(19) United States
(12) Patent Application Publication
(10) Pub. No.: US 2018/0252935 A1
(43) Pub. Date: Sep. 6, 2018

(54) VISION CORRECTION SYSTEM AND METHOD, AND LIGHT FIELD DISPLAY AND BARRIER THEREFOR

(71) Applicant: EVOLUTION OPTIKS LIMITED, BRIDGETOWN (BB)

(72) Inventors: Roel VERTEGAAL, Perth Road Village (CA); Andreas HANEWICH-HOLLATZ, Kingston (CA); Daniel GOTSCH, Kingston (CA)

(21) Appl. No.: 15/910,908

(22) Filed: Mar. 2, 2018

(30) Foreign Application Priority Data
Mar. 3, 2017 (CA) 2959820

(51) Int. Cl. G02B 27/42; G02B 27/44; G09G 5/391; G06T 5/00; G06F 3/0484

(52) U.S. Cl. CPC G02B 27/4205; G02B 27/44; G09G 5/391; G06T 5/003; G09G 2380/14; G06T 2200/24; G09G 2354/00; G09G 2340/0457; G09G 2380/10; G06F 3/04847

(57) ABSTRACT

Described are various embodiments of a digital display device for use by a user having reduced visual acuity. In one embodiment, a digital display device includes: a digital display medium including an array of pixels and operable to render a pixelated image; a diffractive light field barrier overlaying said digital display at a distance therefrom and defined by an array of diffractive optical elements, each of said diffractive optical elements defined by a concentrically patterned barrier centered over a corresponding set of said pixels to diffractively influence a light field emanating therefrom and thereby govern a projection thereof from said display medium toward the user; and a hardware processor operable to output corrected image pixel data to be rendered as a function of a stored characteristic of said diffractive light field barrier and a selected vision correction parameter related to the user's reduced visual acuity.

### CROSS REFERENCE TO RELATED APPLICATIONS

This application claims the benefit of Canadian Patent Application No. 2,959,820, filed Mar. 3, 2017, which is incorporated herein by reference in its entirety.

### FIELD OF THE DISCLOSURE

The present disclosure relates to digital displays, and in particular, to a vision correction system and method, and light field display and barrier therefor.

### BACKGROUND

Individuals routinely wear corrective lenses to accommodate for reduced vision acuity in consuming images and/or information rendered, for example, on digital displays provided, for example, in day-to-day electronic devices such as smartphones, smart watches, electronic readers, tablets, laptop computers and the like, but also provided as part of vehicular dashboard displays and entertainment systems, to name a few examples. The use of bifocals or progresses corrective lenses is also commonplace for individuals suffering from near and far sightedness.

The operating systems of current electronic devices having graphical displays offer certain “Accessibility” features built into the software of the device to attempt to provide users with reduced vision the ability to read and view content on the electronic device. Specifically, current accessibility options include the ability to invert images, increase the image size, adjust brightness and contrast settings, bold text, view the device display only in grey, and for those with legal blindness, the use of speech technology. These techniques focus on the limited ability of software to manipulate display images through conventional image manipulation, with limited success.

The use of 4D light field displays with lenslet arrays or parallax barriers to correct visual aberrations have since been proposed by Pamplona et al. (PAMPLONA, V., OLIVEIRA, M., ALIAGA, D., AND RASKAR, R.2012. “Tailored displays to compensate for visual aberrations.” ACM Trans. Graph. (SIGGRAPH) 31.). Unfortunately, conventional light field displays as used by Pamplona et al. are subject to a spatio-angular resolution trade-off; that is, an increased angular resolution decreases the spatial resolution. Hence, the viewer sees a sharp image but at the expense of a significantly lower resolution than that of the screen. To mitigate this effect, Huang et al. (see, HUANG, F.-C., AND BARSKY, B. 2011. A framework for aberration compensated displays. Tech. Rep. UCB/EECS-2011-162, University of California, Berkeley, December; and HUANG, F.-C., LANMAN, D., BARSKY, B. A., AND RASKAR, R. 2012. Correcting for optical aberrations using multi layer displays. ACM Trans. Graph. (SiGGRAPH Asia) 31, 6, 185:1-185:12. proposed the use of multilayer display designs together with prefiltering. The combination of prefiltering and these particular optical setups, however, significantly reduces the contrast of the resulting image.

Finally, in U.S. Patent Application Publication No. 2016/0042501 and Fu-Chung Huang, Gordon Wetzstein, Brian A. Barsky, and Ramesh Raskar. “Eyeglasses-free Display: Towards Correcting Visual Aberrations with Computational Light Field Displays”. ACM Transaction on Graphics, xx:0, August 2014, the entire contents of each of which are hereby incorporated herein by reference, the combination of viewer-adaptive pre-filtering with off-the-shelf lenslet arrays or parallax barriers has been proposed to increase contrast and resolution, at the expense however, of computation time and power.

However, with the advent of increasingly higher resolution displays, the provision of parallax barriers correspondingly defined by increasingly smaller pinholes can result in various diffractive and/or interferential artifacts that ultimately counteracts attempts to produce higher resolution corrective light field displays, irrespective of the underlying image pre-processing being invoked.

This background information is provided to reveal information believed by the applicant to be of possible relevance. No admission is necessarily intended, nor should be construed, that any of the preceding information constitutes prior art.

### SUMMARY

The following presents a simplified summary of the general inventive concept(s) described herein to provide a basic understanding of some aspects of disclosure. This summary is not an extensive overview of the disclosure. It is not intended to restrict key or critical elements of the disclosure or to delineate the scope of the disclosure beyond that which is explicitly or implicitly described by the following description and claims.

A need exists for a vision correction system and method, and light field display and barrier therefor, that overcome some of the drawbacks of known techniques, or at least, provide a useful alternative thereto. Some aspects of disclosure provide embodiments of such systems, methods, displays and barriers.

In accordance with one aspect, there is provided a digital display device for use by a user having reduced visual acuity, the device comprising: a digital display medium comprising an array of pixels and operable to render a pixelated image accordingly; a diffractive light field barrier overlaying said digital display at a distance therefrom and defined by an array of diffractive optical elements, wherein each one of said diffractive optical elements is defined by a concentrically patterned barrier centered over a corresponding set of said pixels to diffractively influence a light field emanating therefrom and thereby govern a projection thereof from said display medium toward the user; and a hardware processor operable on image pixel data for an image to be displayed to output corrected image pixel data to be rendered as a function of a stored characteristic of said diffractive light field barrier and a selected vision correction parameter related to the user's reduced visual acuity such that said processed image is rendered via said light field barrier to at least partially compensate for the user's reduced visual acuity.

In accordance with one embodiment, each of said diffractive optical elements defines a Fresnel zone plate having two or more concentric rings.

In accordance with one embodiment, each said Fresnel zone plate is defined by a refractive geometry defined by at least one of a respective width of, or distance between, each of said rings.

In accordance with one embodiment, each of said diffractive optical elements defines a photon sieve having two or more concentric rings of pin holes.

In accordance with one embodiment, each said photon sieve is defined by a refractive geometry defined by at least one of a respective size of said pin holes for each of said concentric rings, a respective radial distance between each of said concentric rings, a respective number of pinholes defined for each of said concentric rings, or a circumferential spacing between each of said pinholes defined for each of said concentric rings.

In accordance with one embodiment, the stored characteristic of said diffractive light field barrier comprises at least one of a set distance between said display medium and said diffractive light field barrier, a distance between each of said diffractive optical elements or a number of pixels associated with each of said diffractive optical elements.

In accordance with one embodiment, the device is further operable to render an interactive graphical user interface (GUI) via said display medium, wherein said interactive GUI incorporates a dynamic vision correction scaling function that dynamically adjusts said designated vision correction parameter in real-time in response to a designated user interaction therewith via said GUI.

In accordance with one embodiment, the dynamic vision correction scaling function comprises a graphically rendered scaling function and wherein said designated user interaction comprises a slide motion operation, and wherein said GUI is configured to capture and translate a user's given continuous slide motion operation to a corresponding adjustment to said designated vision correction parameter scalable with a degree of said user's given slide motion operation.

In accordance with one embodiment, the display device includes a digital vehicle user interface, a digital watch, a smartphone, or a digital reader.

In accordance with one embodiment, the concentrically patterned barrier is defined by concentric cut-outs.

In accordance with one embodiment, the image is processed and rendered via the light field barrier to produce a virtual image on a virtual plane at a designated distance from the display medium.

In accordance with another aspect, there is provided a diffractive light field barrier for use with a display medium comprising an array of pixels and operable to render a pixelated image accordingly to be viewed by a viewer having a reduced visual acuity, wherein the diffractive light field barrier is dimensioned to overlay the digital display medium at a distance therefrom and comprises an array of diffractive optical elements, each one of which being defined by a concentrically patterned barrier that, when overlaid onto the digital display medium, is centered over a corresponding set of the pixels to diffractively influence a light field emanating therefrom and thereby govern a projection thereof from the display medium toward the user such that an image can be processed and rendered via the light field barrier to at least partially compensate for the viewer's reduced visual acuity.

In accordance with one embodiment, the image is processed and rendered via the light field barrier to produce a virtual image on a virtual plane at a designated distance from the display medium.

In accordance with one embodiment, each of said diffractive optical elements defines a Fresnel zone plate having two or more concentric rings.

In accordance with one embodiment, each said Fresnel zone plate is defined by a refractive geometry defined by at least one of a respective width of, or distance between, each of said rings.

In accordance with one embodiment, each of said diffractive optical elements defines a photon sieve having two or more concentric rings of pin holes.

In accordance with one embodiment, each said photon sieve is defined by a refractive geometry defined by at least one of a respective size of said pin holes for each of said concentric rings, a respective radial distance between each of said concentric rings, a respective number of pinholes defined for each of said concentric rings, or a circumferential spacing between each of said pinholes defined for each of said concentric rings.

In accordance with one embodiment, the display includes a digital vehicle user interface, a digital watch, a smartphone, or a digital reader.

In accordance with one embodiment, the concentrically patterned barrier is defined by concentric cut-outs.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a diagrammatical view of an electronic device including a digital display, in accordance with one embodiment;

FIGS. 2A and 2B are exploded and side views, respectively, of an assembly of a diffractive light field display barrier overlaying a digital display of an electronic device, in accordance with one embodiment;

FIG. 3 is a diagram illustrating a diffraction pattern produced by each circular pinhole of a traditional parallax barrier, in accordance with one embodiment;

FIG. 4 is a diagram illustrating a diffraction pattern produced by each diffractive optical element, defined by a Fresnel zone plate, of a diffractive light field barrier, in accordance with one embodiment;

FIG. 5A is a diagram of a diffractive light field barrier defined by an array of Fresnel zone plates, in accordance with one embodiment, whereas FIG. 5B is a diagram illustrating an alignment of a given on of the Fresnel zone plates with a corresponding array of underlying display device pixels;

FIG. 6 is a diagram illustrating a diffraction pattern produced by each diffractive optical element, defined by a photon sieve, of a diffractive light field barrier, in accordance with one embodiment; and

FIG. 7A is a diagram of a diffractive light field barrier defined by an array of photon sieves, in accordance with one embodiment, whereas FIG. 7B is a diagram illustrating an alignment of a given on of the photon sieves with a corresponding array of underlying display device pixels, in accordance with one embodiment.

### DETAILED DESCRIPTION

The systems and methods described herein provide, in accordance with different embodiments, different examples of a vision correction system and method, and light field display and barrier therefor. For instance, the devices, displays and methods described herein may allow users who would otherwise require corrective eyewear such as glasses or contact lenses, or again bifocals, to consume images produce by such devices, displays and methods in clear or improved focus without the use of such eyewear.

For example, the embodiments described herein provide for digital display device, or devices encompassing such displays, for use by users having reduced visual acuity, whereby images ultimately rendered by such devices can be dynamically processed to accommodate the user's reduced visual acuity so that they may consume rendered images without the use of corrective eyewear, as would otherwise be required.

Furthermore with the solutions described herein, improvements in image correction and rendering quality can be further extended to increasingly higher display resolutions (e.g. 4K devices and beyond), and thus, higher corrected image resolutions, while circumventing traditional diffractive and/or interferential artifacts common with traditional parallax barrier implementations when seeking to address increasingly higher resolution displays with increasingly smaller parallax barrier pinhole dimensions.

As will be further detailed below, embodiments described herein introduce the use of diffractive light field barriers to traditional light field displays, whereby a particular diffractive light field barrier is overlaid onto a digital display so to govern which of the display's pixels are projected at regions visible by each of the user's eyes, thus providing for an autostereoscopic effect that can be leveraged to produce a virtual image on a virtual plane at a distance from the display to accommodate the user's reduced visual acuity. Other image pre-filtering may also be considered, as noted above, to interface with the diffractive light field barrier in compensating for a user's reduced visual acuity while benefiting from the diffractive properties of the herein-described barrier embodiments.

Generally, each diffractive light field barrier will be defined by an array of diffractive optical elements, which may, for example, comprises of concentrically patterned barriers, e.g. cut outs, centered over corresponding subsets of the display's pixel array to diffractively influence a light field emanating therefrom and thereby govern a projection thereof from the display medium toward the user, for instance, providing some control over how each pixel or pixel group will be viewed by the viewer's eye(s). To do so, the display device will generally invoke a hardware processor operable on image pixel data for an image to be displayed to output corrected image pixel data to be rendered as a function of a stored characteristic of the diffractive light field barrier (e.g. physical barrier distance from display screen, distance between diffractive optical elements, size of diffractive optical elements relative to image pixels, etc.) and a selected vision correction parameter related to the user's reduced visual acuity. While light field display characteristics will generally remain static for a given implementation (e.g., example, a given barrier will be used and set for each device irrespective of the user), image processing will be dynamically adjusted as a function of the user's visual acuity so to actively adjust a distance of the virtual image plane induced upon rendering the corrected image pixel data via the static light field barrier, for example, or otherwise actively adjust image processing parameters as may be considered, for example, when implementing a viewer-adaptive pre-filtering algorithm or like approach, so to at least in part govern an image perceived by the user's eye(s) given pixel-specific light visible thereby through the barrier.

Accordingly, a given device may be adapted to compensate for different visual acuity levels and thus accommodate different users and/or uses. For instance, a particular device may be configured to implement and/or render an interactive graphical user interface (GUI) that incorporates a dynamic vision correction scaling function that dynamically adjusts one or more designated vision correction parameter(s) in real-time in response to a designated user interaction therewith via the GUI. For example, a dynamic vision correction scaling function may comprise a graphically rendered scaling function controlled by a (continuous or discrete) user slide motion or like operation, whereby the GUI can be configured to capture and translate a user's given slide motion operation to a corresponding adjustment to the designated vision correction parameter(s) scalable with a degree of the user's given slide motion operation. These and other examples are described in Applicant's co-pending U.S. patent application Ser. No. 15/246,255, the entire contents of which are hereby incorporated herein by reference.

These and other features of the herein described embodiments will be described in greater detail below.

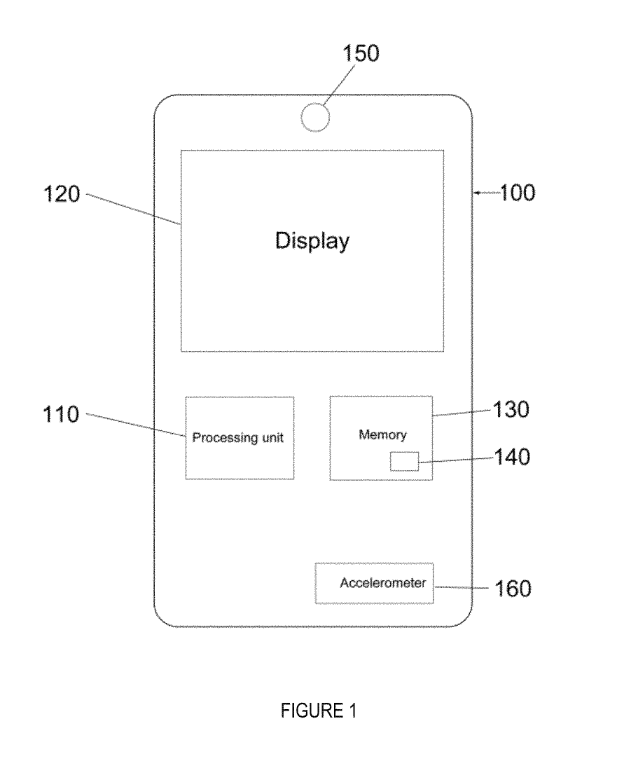

With reference to FIG. 1, and in accordance with one embodiment, a digital display device, generally referred to using the numeral 100, will now be described. In this example, the device 100 is generally depicted as a smartphone or the like, though other devices encompassing a graphical display may equally be considered, such as tablets, e-readers, watches, televisions, GPS devices, laptops, desktop computer monitors, televisions, smart televisions, handheld video game consoles and controllers, vehicular dashboard and/or entertainment displays, and the like.

In the illustrated embodiment, the device 100 comprises a processing unit 110, a digital display 120, and internal memory 130. Display 120 can be an LCD screen, a monitor, a plasma display panel, an LED or OLED screen, or any other type of digital display defined by a set of pixels for rendering a pixelated image or other like media or information. Internal memory 130 can be any form of electronic storage, including a disk drive, optical drive, read-only memory, random-access memory, or flash memory, to name a few examples. For illustrative purposes, memory 130 has stored in it vision correction application 140, though various methods and techniques may be implemented to provide computer-readable code and instructions for execution by the processing unit in order to process pixel data for an image to be rendered in producing corrected pixel data amenable to producing a corrected image accommodating the user's reduced visual acuity (e.g. stored and executable image correction application, tool, utility or engine, etc.). Other components of the electronic device 100 may optionally include, but are not limited to, a rear or front-facing camera 150, an accelerometer 160 and/or other device positioning/orientation devices capable of determining the tilt and/or orientation of electronic device 100, and the like.

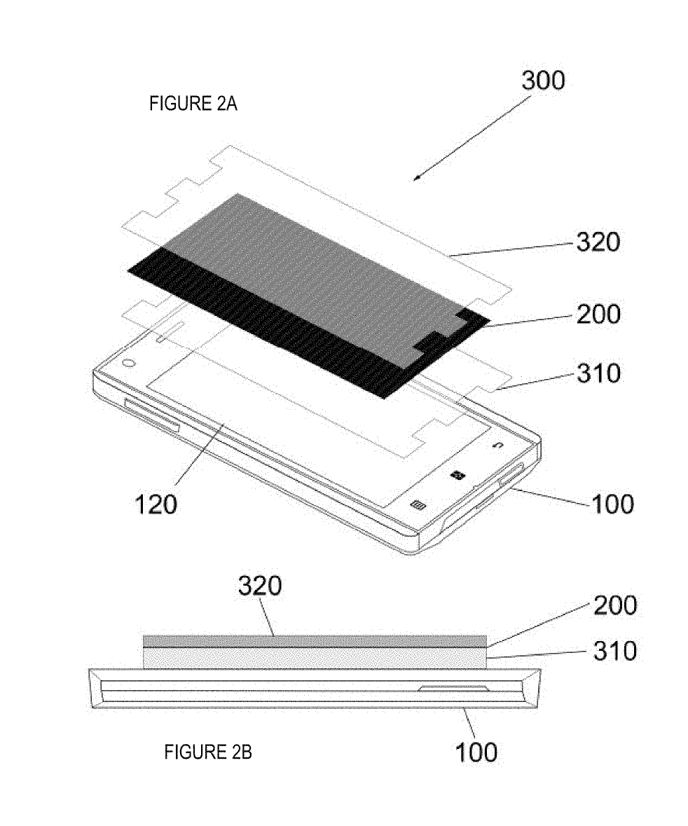

With reference to FIGS. 2A and 2B, the electronic device 100, such as that illustrated in FIG. 1, is further shown to include a diffractive light field barrier 200 overlaid atop a display 120 thereof and spaced therefrom via a transparent spacer 310. An optional transparent screen protector is also included atop the barrier 200.

It will be appreciated that the various components illustrated are not drawn to scale, but rather provided for illustrative purposes. For example, in one embodiment, the transparent spacer 310 may be of a thickness in the order of 2 to 20 mm, though other thickness may also apply depending on the application at hand, and the various image parameters contemplated. Clearly, the spacer thickness and other parameters associated with the disposition of the barrier may vary depending on the resolution of the screen, the intended application and thus the general distance between the user's eyes and the display in use (e.g. smartphone vs. vehicular dashboard), the extent of the visual correction capacity required or desired, the intended resolution, brightness, contrast and like parameters of the corrected image, and the like.

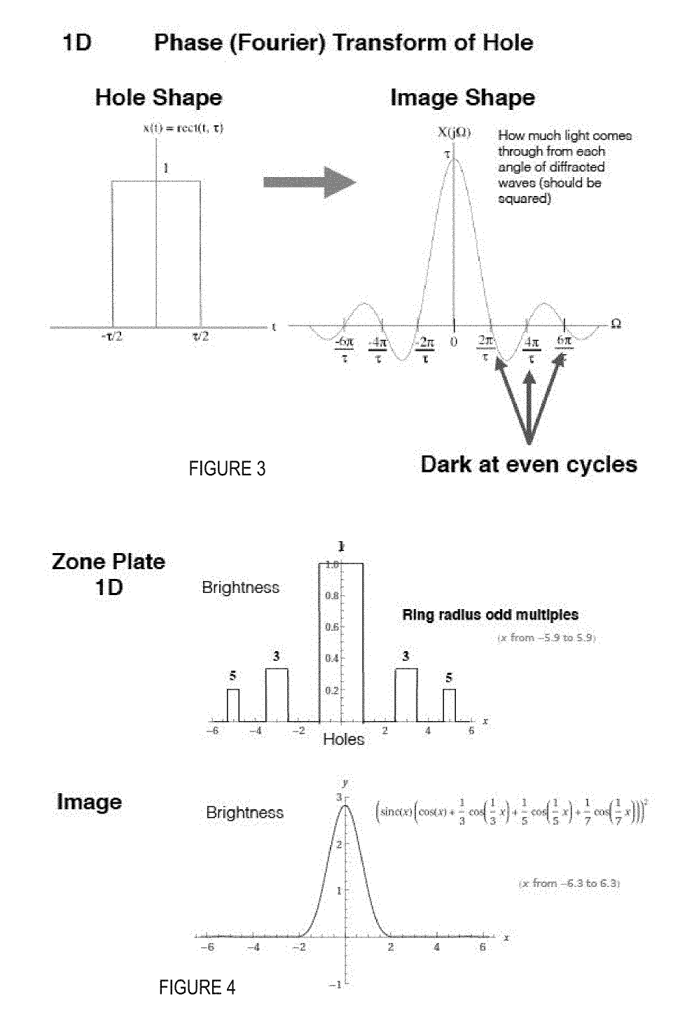

With reference to FIG. 3, the general diffraction pattern induced when using a traditional parallax barrier having circular pinholes is shown, whereby diffractive peaks alongside the central peak can significantly blur the resulting virtual image when such diffractive peaks are compounded over multiple pinholes, and thus impede effective image correction and user visual acuity accommodation.

In order to address diffractive blurring, the embodiments considered herein introduce the use of constructively diffractive pinhole geometries which, when used to replace traditional circular pinholes, can achieve much sharper images without or with much reduced diffractive blurring. For example, and as graphically illustrated in FIG. 4, by introducing, in lieu of a pinhole array, a corresponding array of constructively diffractive optical elements, a sharp virtual image may be more readily achieved, as illustrated by the simulated peak shown in this figure as a result of light being shone through zone plate having three “concentric” ring “cut outs” or “windows”. Namely, the concentric pattern defined for this purpose provides for constructive light wave interference, by obstructing alternate Fresnel zones (even or odd) and resulting in a transmission peak centered on the optical axis of the zone plate at a given focal distance.

Accordingly, by replacing respective pinholes in a pinhole array forming a traditional parallax barrier, with corresponding diffractive optical elements defined by a diffractively constructive concentrically patterned barrier, diffractive blurring can be significantly reduced. Furthermore, as diffractive blurring is reduced, the size of each diffractive element may also be reduced to accommodate increasingly higher resolution screens, and thus increasingly higher resolution corrected images.

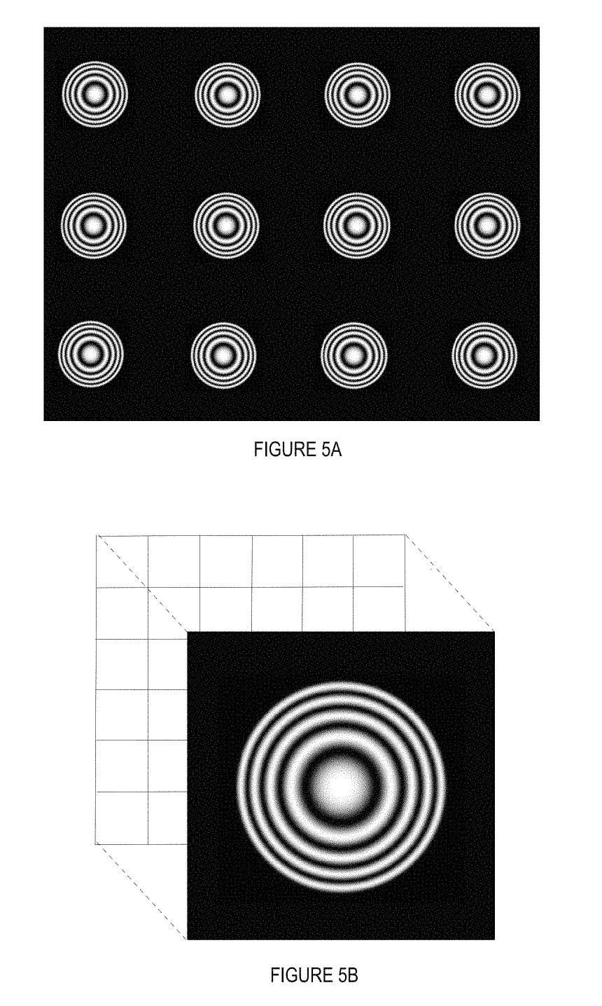

With reference to FIG. 5A, an illustrative refractive light field barrier 500 is shown to include a rectangular array distribution of concentrically patterned diffractive “cut-outs” 510, in this example, each comprising a zone plate (also known as a Fresnel zone plate). Other embodiments may use a hexagonal distribution (not shown). As shown in FIG. 5B, each zone plate 510 is aligned with a corresponding set of pixels array to optically govern visibility of light emanating from these pixels, effectively thus dictating how light emanating from these pixels will be projected from the screen.

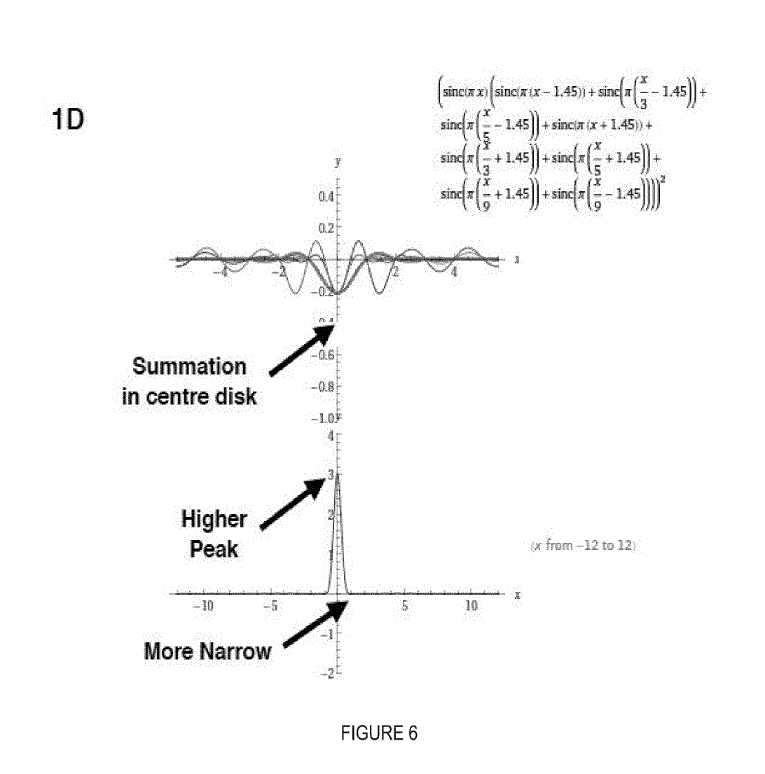

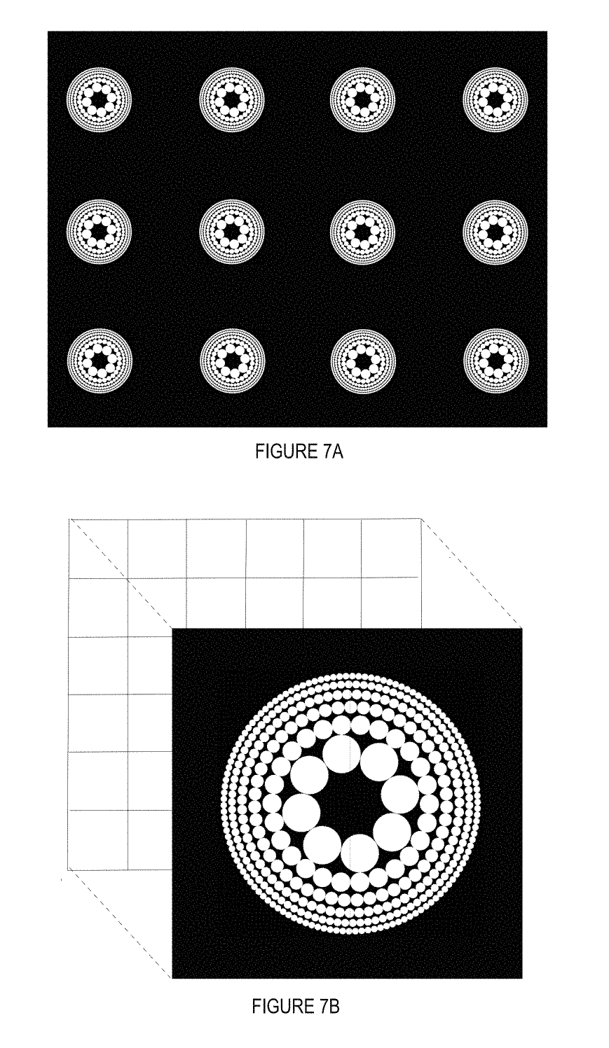

With reference to FIGS. 7A and 7B, an alternative diffractive light field barrier 700 again employs concentrically patterned “cutouts” 710 defining constructively diffractive optical elements, in this case, comprising concentric rings of circular cut outs, apertures or “windows”, otherwise known as photon sieves. As graphically illustrated at FIG. 6, constructive interference between diffractive outputs for a given photon sieve as shown in FIG. 7B, for example, results in a sharper peak, thus allowing for a further increase in virtual image resolution. It will be noted that the example shown in FIG. 7B does not include a central aperture as was otherwise included in the zone plate embodiment of FIG. 5A.

In order to optimize the light field barrier for a given application, different parameters may be adjusted, such as the hole size of the pinhole cutouts within each given ring (or width of each given ring), distance between rings, number of pinholes within each given ring and/or circumferential distance between pinholes. For example, in one embodiment, parameters such as the size of the holes, which govern the frequency of the resulting sinc functions, and the distance of the hole to the center, may be designated to optimize optical image output performance. For instance, together, these two parameters can govern the alignment of the first harmonic of the sinc function, being the negative first bulge of the sinc function, with the center of the hole, the mathematical development of which is illustrated in FIG. 6.

Using the above-described embodiments, the display device can be configured to render a corrected image via the diffractive light field barrier that accommodates for the user's visual acuity. By adjusting the image correction in accordance with the user's actual predefined, set or selected visual acuity level, different users and visual acuity may be accommodated using a same device configuration. That is, in one example, by adjusting corrective image pixel data to dynamically adjust a virtual image distance below/above the display as rendered via the diffractive light field barrier, different visual acuity levels may be accommodated.

As will be appreciated by the skilled artisan, different image processing techniques may be considered, such as those introduced above and taught by Pamplona and/or Huang, for example, which may also influence the size of diffractive optical elements required to correspond with appropriate pixel arrays required to achieve appropriate image correction, virtual image resolution, brightness and the like.

While the present disclosure describes various exemplary embodiments, the disclosure is not so limited. To the contrary, the disclosure is intended to cover various modifications and equivalent arrangements included within the general scope of the present disclosure. Various components illustrated in the figures may be implemented as hardware and/or software and/or firmware on a processor, ASIC/FPGA, dedicated hardware, and/or logic circuitry. Also, the features and attributes of the specific embodiments disclosed above may be combined in different ways to form additional embodiments, all of which fall within the scope of the present disclosure. Although the present disclosure provides certain embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A digital display device for use by a user having reduced visual acuity, the device comprising:
a digital display medium comprising an array of pixels and configured to render a pixelated image;
a diffractive light field barrier overlaying said digital display at a distance therefrom and including an array of diffractive optical elements, wherein each one of said diffractive optical elements includes a concentrically patterned barrier centered over a corresponding set of said pixels to diffractively influence a light field emanating therefrom and thereby govern a projection thereof from said display medium toward the user; and
a hardware processor configured to process image pixel data for an image to be displayed to output corrected image pixel data to be rendered as a function of a stored characteristic of said diffractive light field barrier and a selected vision correction parameter related to the user's reduced visual acuity such that said processed image is rendered via said light field barrier to at least partially compensate for the user's reduced visual acuity.

2. The display device of claim 1, wherein each of said diffractive optical elements defines a Fresnel zone plate including two or more concentric rings.

3. The display device of claim 2, wherein each said Fresnel zone plate is defined by a refractive geometry defined by at least one of a respective width of, or distance between, each of said rings.

4. The display device of claim 1, wherein each of said diffractive optical elements defines a photon sieve including two or more concentric rings of pin holes.

5. The display device of claim 4, wherein each said photon sieve is defined by a refractive geometry defined by at least one of: a respective size of said pin holes for each of said concentric rings, a respective radial distance between each of said concentric rings, a respective number of pinholes defined for each of said concentric rings, or a circumferential spacing between each of said pinholes defined for each of said concentric rings.

6. The display device of claim 1, wherein said stored characteristic of said diffractive light field barrier comprises at least one of: a set distance between said display medium and said diffractive light field barrier, a distance between each of said diffractive optical elements or a number of pixels associated with each of said diffractive optical elements.

7. The display device of claim 1, wherein the hardware processor is further configured to render an interactive graphical user interface (GUI) via said display medium, wherein said interactive GUI incorporates a dynamic vision correction scaling function that dynamically adjusts said designated vision correction parameter in real-time in response to a designated user interaction therewith via said GUI.

8. The display device of claim 7, wherein said dynamic vision correction scaling function comprises a graphically rendered scaling function and wherein said designated user interaction comprises a slide motion operation, and wherein said GUI is configured to capture and translate a user's given continuous slide motion operation to a corresponding adjustment to said designated vision correction parameter scalable with a degree of said user's given slide motion operation.

9. The display device of claim 1, wherein the display device comprises a digital vehicle user interface, a digital watch, a smartphone, or a digital reader.

10. The display device of claim 1, wherein said concentrically patterned barrier is defined by concentric cut-outs.

11. The display device of claim 1, wherein said image is processed and rendered via the light field barrier to produce a virtual image on a virtual plane at a designated distance from the display medium.

12. A diffractive light field barrier for use with a display medium comprising an array of pixels and configured to render a pixelated image to be viewed by a viewer having a reduced visual acuity, wherein the diffractive light field barrier is dimensioned to overlay the digital display medium at a distance therefrom and comprises an array of diffractive optical elements, each one of which being including a concentrically patterned barrier that, when overlaid onto the digital display medium, is centered over a corresponding set of the pixels to diffractively influence a light field emanating therefrom and thereby govern a projection thereof from the display medium toward the user such that an image can be processed and rendered via the light field barrier to at least partially compensate for the viewer's reduced visual acuity.

13. The diffractive light field barrier of claim 12, wherein said image is processed and rendered via the light field barrier to produce a virtual image on a virtual plane at a designated distance from the display medium.

14. The diffractive light field barrier of claim 12, wherein each of said diffractive optical elements defines a Fresnel zone plate including two or more concentric rings.

15. The diffractive light field barrier of claim 14, wherein each said Fresnel zone plate is defined by a refractive geometry defined by at least one of a respective width of, or distance between, each of said rings.

16. The diffractive light field barrier of claim 12, wherein each of said diffractive optical elements defines a photon sieve including two or more concentric rings of pin holes.

17. The diffractive light field barrier of claim 16, wherein each said photon sieve is defined by a refractive geometry defined by at least one of a respective size of said pin holes for each of said concentric rings, a respective radial distance between each of said concentric rings, a respective number of pinholes defined for each of said concentric rings, or a circumferential spacing between each of said pinholes defined for each of said concentric rings.

18. The diffractive light field barrier of claim 12, wherein the display comprises a digital vehicle user interface, a digital watch, a smartphone, or a digital reader.

19. The diffractive light field barrier of claim 12, wherein said concentrically patterned barrier is defined by concentric cut-outs.
